(19) United States
(12) Patent Application Publication
(10) Pub. No.: US 2021/0021724 A1
(43) Pub. Date: Jan. 21, 2021

(54) ELECTRONIC DEVICE

(71) Applicant: SEIKO EPSON CORPORATION, Tokyo (JP)

(72) Inventors: Nobuhiro TSUJIOKA, Matsumoto (JP); Yasumichi OKUDA, Matsumoto (JP); Tetsuya ASANO, Matsumoto (JP)

(21) Appl. No.: 17/063,315

(22) Filed: Oct. 5, 2020

Related U.S. Application Data
(63) Continuation of application No. 15/866,283, filed on Jan. 9, 2018.

(30) Foreign Application Priority Data
Jan. 19, 2017 (JP) 2017-007299

(51) Int. Cl. H04N 1/00; B41J 29/393; G06F 9/451; G06F 3/0482; G06F 3/0489

(52) U.S. Cl. CPC H04N 1/00411; B41J 29/393; G06F 3/04895; G06F 9/453; G06F 3/0482; H04N 1/00413

(57) ABSTRACT

An electronic device includes a display; a processor configured to allow the display to display guidance images for providing guidance on operations of the electronic device; and at least one sensor configured to detect a user's execution of at least one operation among the operations. When receiving a transition instruction for instructing a transition of the guidance image, the processor allows the display of the guidance image to transit on a guidance-image by guidance-image basis, and when an execution of a predetermined operation is detected by the at least one sensor, the processor allows the display of the guidance image to transit in such a way as to skip one or more guidance images among the guidance images.

The present application is a continuation of U.S. patent application Ser. No. 15/866,283, filed Jan. 9, 2018, which claims priority to Japanese Patent Application No. 2017-007299, filed Jan. 19, 2017, the disclosures of which are expressly incorporated by reference herein in their entirety.

### BACKGROUND

### 1. Technical Field

The present invention relates to an electronic device that displays guidance images for providing guidance on operations.

### 2. Related Art

In a device for which a user is required to perform some operations for settings necessary to utilize the device, guidance images for providing guidance on the operations are displayed.

Further, there is known an image forming apparatus that includes an attachment/detachment detection portion configured to detect user's attachment and detachment operations for an optional device, and that allows a display control portion to change a guidance displayed on a display portion in response to the result of the detection by the attachment/detachment detection portion (see JP-A-2016-87878).

In the case where a user is required to manually switch the display of a guidance image on a display portion in conjunction with the progress of the operations, a heavy burden has been imposed on the user. Particularly, for skilled users who are able to perform the settings without confirming the guidance images one by one, the operation of switching each of the guidance images has been troublesome. Moreover, there may occur a case where, in order to perform operations of a device, a user is required to move to positions, such as a position on the rear side of the device, at which it is difficult to view the display portion, and in such a case, it has been a burden for the user to view each of the guidance images displayed on the display portion and switch each of the guidance images.

### SUMMARY

An advantage of some aspects of the invention is that an electronic device that is effective in the reduction of a burden on a user is provided.

An electronic device according to an aspect of the invention includes a display; a processor configured to allow the display to display guidance images for providing guidance on operations of the electronic device; and at least one sensor configured to detect a user's execution of at least one operation among the operations. Further, when receiving a transition instruction for instructing a transition of the guidance image, the processor allows the display of the guidance image to transit on a guidance-image by guidance-image basis, and when an execution of a predetermined operation is detected by the at least one sensor, the processor allows the display of the guidance image to transit in such a way as to skip one or more guidance images among the guidance images.

According to this configuration, when receiving a transition instruction from a user for instructing a transition of the guidance image, the electronic device allows the display of the guidance image to transit on a guidance-image by guidance-image basis. On the contrary, when an execution of a predetermined operation is detected by the at least one sensor, the electronic device allows a guidance image currently displayed by the display to skip one or more guidance images and transit to a guidance image that is the destination of the skip. That is, when a user desires to confirm the guidance images on a guidance-image by guidance-image basis, the user is able to allow the display of the guidance image to transit on a guidance-image by guidance-image basis manually (in a way using the transition instructions). Further, the user is able to, without viewing the guidance images and issuing the transition instructions, successively execute the operations while allowing the display of the guidance image to transit automatically (while allowing the display of the guidance image to transit in such a way as to skip one or more guidance images). Accordingly, a burden on the user, such as described above, is reduced.

According to a preferred configuration of the electronic device according to the aspect of the invention, the processor may be configured to enable the display to sequentially display each of a plurality of guidance image sets, each of the guidance image sets including a plurality of guidance images each of which is associated with a corresponding one of a plurality of successive operations. Further, when an execution of one of the operations that corresponds to a last guidance image of a first guidance image set among the guidance image sets is detected by the at least one sensor, the processor may allow the display of the guidance image by the display to transit to an initial guidance image of a second guidance image set subsequent to the first guidance image set among the guidance image sets.

According to this configuration, regardless of which of guidance images of a guidance image set is currently displayed on the display, when a user has executed an operation corresponding to the last guidance image of the relevant guidance image set (when the execution of the relevant operation is detected by at least one sensor), the processor allows the display of the guidance image to transit straight to the initial guidance image of a guidance image set subsequent to the relevant guidance image set. With this configuration, the user is released from a burden of switching the guidance images one by one manually (in a way using the transition instructions).

According to a preferred configuration of the electronic device according to the aspect of the invention, the successive operations associated with the respective guidance images constituting each of the guidance image sets may include one or more operations undetectable by the at least one sensor.

According to this configuration, cost reduction of the electronic device is achieved in such a way that no sensor for the detection is provided on some operations on which guidance is provided by guidance images.

According to a preferred configuration of the electronic device according to the aspect of the invention, when the execution of one of the operations that corresponds to the last guidance image of the first guidance image set among the guidance image sets is detected by the at least one sensor, under a condition that all of operations each associated with a corresponding one of guidance images constituting the first guidance image set and each of which is detectable by the at least one sensor have already been executed, the processor may allow the display of the guidance image by the display to transit to the initial guidance image of the second guidance image set subsequent to the first guidance image set among the guidance image sets.

According to this configuration, it is achieved that, after the confirmation of the proper execution of all of at least one operation each detectable by the at least one sensor, a guidance image set displayed on the display is allowed to transit to a next guidance image set.

In the above case where the execution of the one of the operations that corresponds to the last guidance image of the first guidance image set is detected by the at least one sensor, unless the condition is satisfied, the processor may maintain the display of the guidance image by the display. This configuration enables a user to recognize that part of the operations is not yet properly executed.

According to a preferred configuration of the electronic device according to the aspect of the invention, when the execution of one of the operations that corresponds to, among guidance images constituting the first guidance image set, a guidance image not corresponding to a last guidance image is detected by the at least one sensor, the processor may allow the display of the guidance image by the display to transit to, among the guidance images constituting the first guidance image set, a guidance image subsequent to the guidance image corresponding to the detected one of the operations.

According to this configuration, it is also achieved that the transition of the display of the guidance image within a guidance image set is made by being triggered by a detection of one of the at least one operation, made by the at least one sensor.

According to a preferred configuration of the electronic device according to the aspect of the invention, when receiving the transition instruction in a status in which, among guidance images constituting the first guidance image set, a guidance image not corresponding to the last guidance image is being displayed by the display, the processor may allow the display of the guidance image to transit by one guidance image regardless of whether or not one of the operations that corresponds to the guidance image being displayed by the display is detected by the at least one sensor.

According to this configuration, a user is able to confirm any of guidance images within a guidance image set in such a way as to allow the display of the guidance image to transit one by one manually (in a way using the transition instructions).

According to a preferred configuration of the electronic device according to the aspect of the invention, among guidance images constituting each of the guidance image sets, each of guidance images not corresponding to the last guidance image may include a reception portion for receiving the transition instruction.

According to this configuration, among guidance images constituting each of the guidance image sets, each of guidance images not corresponding to the last guidance image includes a reception portion for receiving the transition instruction, thereby enabling a user to allow the display of the guidance image to transit one by one manually (in a way using the transition instructions). Further, the last guidance image of each of the guidance image sets does not include the reception portion, thereby allowing the transition to a next guidance image set when an operation corresponding to the last guidance image is detected by the at least one sensor to be ensured.

According to a preferred configuration of the electronic device according to the aspect of the invention, the relevant electronic device may further include a reporting section configured to perform reporting for prompting a user to execute the operation, and the reporting section performs the reporting in conjunction with the guidance image displayed by the display. According to this configuration, error made by a user in the corresponding operation is reduced.

In addition to the above configuration, the reporting section may be disposed in a vicinity of a portion that is a target of the corresponding operation in the electronic device. According to this configuration, a user is able to, without failing to recognize the portion that is the target of the corresponding operation in the electronic device, perform the necessary operation.

The technical concept of the invention is realized in categories other than the category of the electronic device. For example, a method including processes executed by the electronic device (a display control method for guidance images) as well as a program that allows a computer to execute the processes can be deemed as another aspect of the invention. Moreover, a storage medium being readable by a computer and storing the program therein can be also deemed as another aspect of the invention.

### BRIEF DESCRIPTION OF THE DRAWINGS

The invention will be described with reference to the accompanying drawings, wherein like numbers reference like elements.

FIG. 1 is a diagram simply illustrating a configuration of an electronic device according to an embodiment of the invention.

FIG. 2 is a diagram schematically illustrating display control processing for guidance images, according to the embodiment.

FIG. 3 is a diagram illustrating display control processing for guidance images for medium setting processing, according to the embodiment.

FIG. 4 is a diagram simply illustrating a structure of an electronic device serving as an LFP from a lateral side.

### DESCRIPTION OF EXEMPLARY EMBODIMENTS

Hereinafter, an embodiment of the invention will be described with reference to the individual figures. Note that the individual figures are just exemplifications for describing this embodiment.

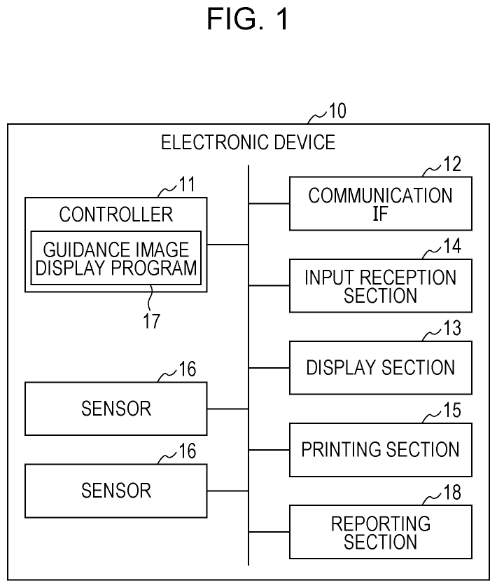

FIG. 1 simply illustrates a configuration of an electronic device according to the present embodiment, that is, an electronic device 10 (hereinafter referred to as a device 10). In FIG. 1, the device 10 is a printer. This printer is an apparatus functioning as a printer at minimum, and may be configured as a multi-function device integrating a plurality of functions, such as a function as a scanner and a function as a facsimile machine. In this regard, however, the device 10 that is assumed in the present embodiment is not limited to the printer, but is applicable to the whole of electronic devices each configured to display guidance images for providing guidance to a user on some operations for settings necessary for the user to utilize the device 10 itself.

The device 10 is configured to include a controller 11, a communication interface (IF) 12, a display section 13, an input reception section 14, a printing section 15, sensors 16, and the like. The controller 11 is constituted by, for example, an IC including a CPU, a ROM, a RAM, and the like, other memory devices, and any other component. The controller 11 controls the behaviors of individual portions of the device 10, such as the printing section 15, by allowing the CPU to execute arithmetic processes in accordance with firmware and programs stored in the ROM and the like using the RAM and the like as work areas. In the controller 11, a guidance image display program 17 is installed as a kind of such programs.

The communication IF 12 is a collective designation of IFs that comply with predetermined communication standards and that communicate with external devices (for example, a personal computer, a digital still camera, a smartphone, a server over a network, and/or the like) through wire communication and wireless communication.

The display section 13 is a means for displaying visual information, and is constituted by, for example, a liquid crystal display (LCD), an organic EL display, or the like. The display section 13 may be configured to include a display and a drive circuit for driving this display.

The input reception section 14 is a means for receiving an input by a user, and is constituted by, for example, a touch panel, physical buttons, a keyboard, or the like. Naturally, the display section 13 also functions as such a touch panel. The input reception section 14 and the display section 13 can be collectively referred to as an operation panel of the device 10.

The printing section 15 is a mechanism for executing printing based on printing data, and executes the printing using, for example, an ink jet method. The printing section 15 includes, as commonly known, a medium holding portion for holding a printing medium, such as paper; a transport portion for transporting the printing medium from a feeding side to an ejection side; a printing head for discharging liquids, such as inks, onto the printing medium having been transported; a carriage for scanning the printing head; ink cartridges for containing and keeping the inks to be supplied to the printing head, and the like. Note that a printing method employed as the printing method of the printing section 15 is not limited to the ink jet method, and various methods, such as an electronic picture method, can be employed.

The sensors 16 are means for detecting operations by a user on the device 10, and these plurality of sensors 16 are disposed on some portions of the device 10. A specific example of the sensors 16 will be described later.

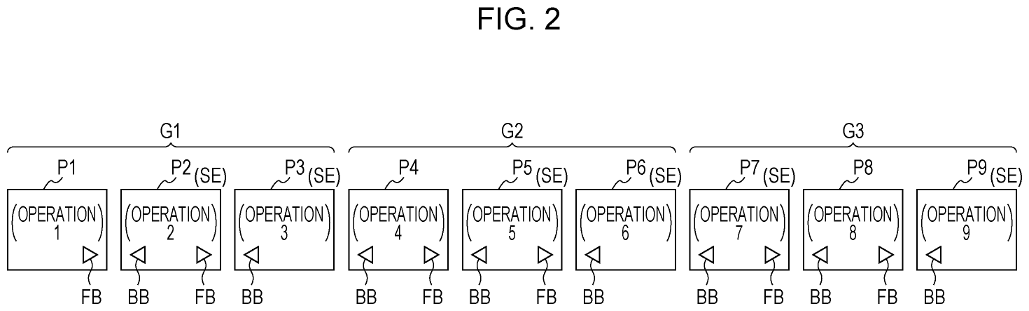

FIG. 2 is a diagram for use in schematically describing display control processing for guidance images that is executed by the controller 11 in accordance with the guidance image display program 17. Based on the display control processing, the controller 11 allows the display section 13 to display guidance images for sequentially providing guidance on operations necessary for settings in relation to the device 10. The settings in relation to the device 10 mean various settings, such as medium setting processing including the attachment of the printing medium to the medium holding section, setting processing including the attachment of the ink cartridges, and initial settings necessary for starting the utilization of the printer (the device 10).

FIG. 2 illustrates guidance images P1 to P9 as examples of the guidance images displayed by the display section 13. The controller 11 retains image data representing these guidance images in advance, and allows the display section 13 to display the guidance images on the basis of the image data. Although omitted in FIG. 2, each of the guidance images P1 to P9 provides a specific guidance on an operation to be executed by a user by means of, for example, an illustration, a message, or a combination thereof.

One guidance image is an image for providing guidance to a user on basically one operation (or an aggregate of operations). In FIG. 2, an operation on which guidance is provided by each of the guidance images is shown in conjunction with the each guidance image, such as an operation 1, an operation 2, an operation 3, . . . . A user views the guidance images P1, P2, P3, P4, P5, P6, P7, P8, and P9 in this order, and thereby is able to sequentially understand and execute the plurality of operations (the operations 1, 2, 3, . . . ) necessary for the settings in relation to the device 10. In this regard, however, there are persons skilled in the settings of the device 10 among users, and thus, the present embodiment does not compel every user to view all of the guidance images.

The controller 11 manages the plurality of guidance images by separating them into some groups. In an example shown in FIG. 2, hereinafter, the guidance images P1, P2, and P3 will be referred to as an image group G1; the guidance images P4, P5, and P6 will be referred to as an image group G2; and guidance images P7, P8, and P9 will be referred to as an image group G3. That is, the controller 11 is capable of displaying the image groups G1, G2, and G3 on the display section 13 in this order. Such an image group corresponds to the guidance image set including a plurality of guidance images each associated with a corresponding one of a plurality of successive operations. Naturally, in the present embodiment, the number of the image groups as well as the number of the guidance images constituting each of the image groups is not limited to any particular number.

A transition (switching) of a guidance image is executable by a transition instruction by a user for instructing the transition of the guidance image. That is, when a transition instruction from a user has been received via the operation panel (the display section 13 and the input reception section 14), the controller 11 allows the display of the guidance image by the display section 13 to transit on a guidance-image by guidance-image basis. For example, each of the guidance images includes a “forward” button FB and a “backward” button BB. The button FB is used for allowing the display of the each guidance image to transit forward by one image, and the button BB is used for allowing the display of the each guidance image to transit backward by one image. Each of the buttons FB and BB is an example of a reception portion for receiving the transition instruction for instructing a transition of the display of the guidance image. For example, when, in a status in which a guidance image P2 is displayed on the display section 13, a user has pushed down (has tapped or clicked) the FB button on the guidance image P2, the controller 11 allows the display of the guidance image by the display section 13 to transit from the guidance image P2 being currently displayed to a guidance image P3, which is a guidance image subsequent to the guidance image P2. Further, when the user has pushed down the BB button on the guidance image P2, the controller 11 allows the display by the display section 13 to transit from the guidance image P2 being currently displayed to a guidance image P1, which is a guidance image one before the guidance image P2. With this configuration, particularly, a user who is not skilled in the settings of the device 10 is able to perform the operations necessary for the settings while confirming the guidance images on a guidance-image by guidance-image basis.

Moreover, in the present embodiment, the controller 11 is capable of executing the transition of the display of the guidance images by being triggered by a detection of a predetermined operation, which is made by one of the sensors 16. In FIG. 2, it is exemplified that, for some of the guidance images P1 to P9, corresponding operations are operations detectable by the sensors 16 (i.e., detection target operations SE). In the example shown in FIG. 2, an operation 2 corresponding to the guidance image P2, an operation 3 corresponding to the guidance image P3, an operation 5 corresponding to the guidance image P5, an operation 7 corresponding to the guidance image P7, and an operation 9 corresponding to the guidance image P9 are the detection target operations SE. Operations other than the detection target operations SE, that is, operations undetectable by the sensors 16 (operations 1, 4, and 8 in the example shown in FIG. 2), will be referred to as detection non-target operations.

When a predetermined operation has been detected by one of the sensors 16, the controller 11 is capable of allowing the display of the guidance image by the display section 13 to transit in such a way as to skip one or more guidance images. The predetermined operation mentioned here is basically an operation corresponding to the last guidance image in each of the image groups. In FIG. 2, for example, the operation 3 corresponding to the last guidance image P3 of the image group G1, the operation 6 corresponding to the last guidance image P6 of the image group G2, and the like correspond to the predetermined operations. As described above, the operations on the device 10 are divided into the detection target operations SE and the detection non-target operations, and in such operations on the device 10, an operation corresponding to the last guidance image of each of the image groups is assumed to be one of the detection target operations SE.

It is assumed that the execution of the operation 3 corresponding to the guidance image P3, which is the last guidance image of the image group G1, has been detected by one of the sensors 16, and the relevant detection thereof has been notified to the controller 11. In response to the notification, the controller 11 allows the display of the guidance image by the display section 13 to transit to a guidance image for providing guidance on an operation subsequent to the operation 3, that is, the guidance image P4, which is the first guidance image of the image group G2 subsequent to the image group G1. In this case, regardless of whichever of the guidance images a guidance image having been displayed by the display section 13 until just before is, the controller 11 allows the display of the guidance image to transit to the guidance image P4. For example, in the case where, in a status in which the guidance image P1 of the image group G1 is displayed on the display section 13, the execution of the operation 3 corresponding to the guidance image P3, which is the last guidance image of the same image group G1, has been detected by one of the sensors 16, the controller 11 allows the guidance images P2 and P3 to be skipped (without allowing the guidance images P2 and P3 to be displayed), and then allows the display section 13 to display the guidance image P4.

Note that, in the case where, in a status in which the guidance image P3 is displayed on the display section 13, the execution of the operation 3 has been detected by one of the sensors 16, the controller 11 also allows the display section 13 to display the guidance image P4, but this case does not correspond to the case where guidance images are skipped.

Further, it is assumed that the execution of the operation 6 corresponding to the guidance image P6, which is the last guidance image of the image group G2, has been detected by one of the sensors 16, and the relevant detection thereof has been notified to the controller 11. In response to the notification, regardless of whichever of the guidance images a guidance image having been displayed by the display section 13 until just before is, the controller 11 allows the display of the guidance image by the display section 13 to transit to a guidance image for providing guidance on an operation subsequent to the operation 6, that is, the guidance image P7, which is the first guidance image of the image group G3.

Note that, in the case where, among guidance images constituting each of the image groups, an execution of an operation corresponding to a guidance image that does correspond to a last guidance image has been detected by one of the sensors 16, the controller 11 may allow the display of the guidance image by the display section 13 to transit to a guidance image subsequent to the guidance image corresponding to the detected operation. As an example, in the case where the operation 2 corresponding to the guidance image P2 of the image group G1 has been detected by one of the sensors 16, regardless of whichever of the guidance images a guidance image having been displayed until just before is, the controller 11 allows the display of the guidance image by the display section 13 to transit to the guidance image P3 corresponding to the operation 3 subsequent to the operation 2.

That is, the transition of the guidance image within each of the image groups can be also executed by being triggered by a detection of an operation, which is made by one of the sensors 16, and in this case, the skip of one or more guidance images may occur. In this regard, however, such a detection, by one of the sensors 16, of an operation corresponding to a guidance image that does not correspond to a last guidance image within each of the image groups does not become the trigger of the transit to a next image group.

Further, in the case where, in a status in which, among guidance images constituting each of the image groups, a guidance image that does not correspond to a last guidance image is displayed by the display section 13, a transition instruction from a user has been received, regardless of whether or not an operation corresponding to the displayed guidance image has been detected by one of the sensors 16, the controller 11 allows the display of the guidance image by the display section 13 to transit by one image. For example, as already described above, in the case where, in a status in which the guidance image P2 is displayed on the display section 13, the guidance button FB on the guidance image P2 has been pushed down, even though the operation 2 corresponding to the guidance image P2 is not detected by a corresponding one of the sensors 16, the controller 11 allows the display by the display section 13 to transit from the guidance image P2 to the guidance image P3, which is a guidance image subsequent to the guidance image P2.

The reception portion (the buttons FB and BB) for receiving the transition instruction for instructing a transition of the guidance image may be provided on each guidance image, regardless of whether or not the each guidance image corresponds to the last guidance image of each of the image groups. In the example shown in FIG. 2, however, such a reception portion is provided on, among guidance images constituting each of the image groups, each of guidance images that do not correspond to the last guidance image; while the reception portion (particularly, the button FB) is not provided on the last image of the each image group. This configuration in which the reception portion (the button FB) is not provided on the last guidance image of the each image group ensures a mechanism in which the transition from a current image group to a next image group is made only in the case where an operation corresponding to the last guidance image of the current image group has been executed with certainty.

As described above, the operations corresponding to the respective guidance images are divided into the detection target operations SE and the detection non-target operations, and if the number and the kinds of the sensors 16 mounted in the device 10 are increased, all of the operations could be handled as the detection target operations SE. In this case, however, the increase of the number and the kinds of the sensors 16 increases the manufacturing cost of the device 10. In view of the reduction of such cost, the device 10 is configured to mount the sensors 16 at limited portions in such a way as to enable the detection of the executions of operations that are among a plurality of operations necessary for the settings of the device 10 and that, if not normally executed, may become causes of relatively critical problems.

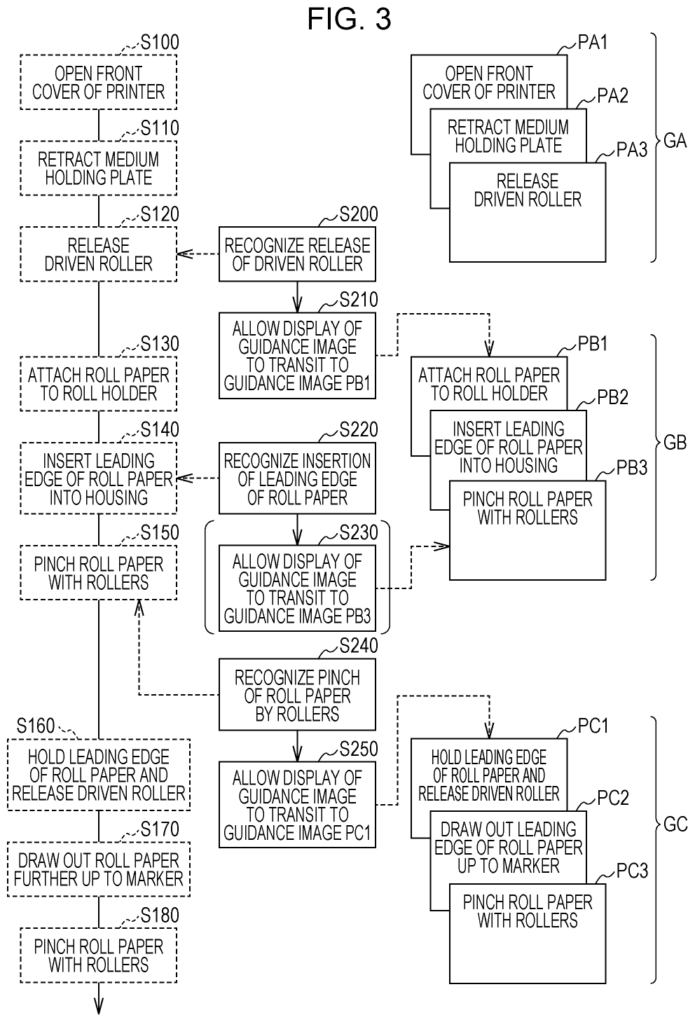

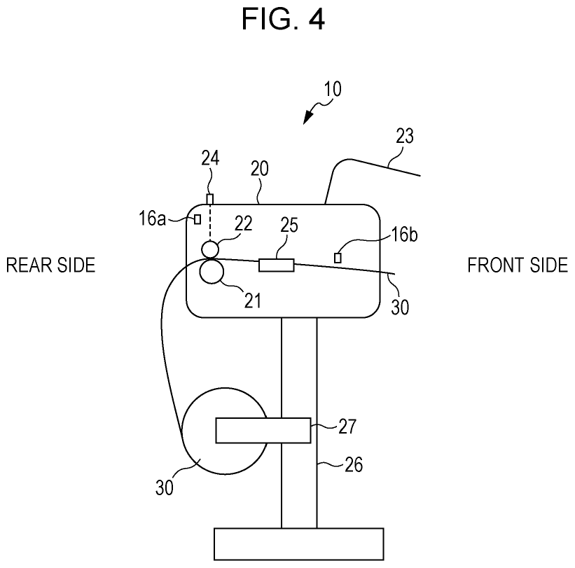

Based on the description so far, the display control processing for the guidance images will be described on an assumption of further specific scenes. As an example, it is assumed that the device 10 is a so-called large format printer (LFP), and when processing for attaching roll paper, which is a kind of the printing media, to the device 10, and the like (i.e., medium setting processing) is performed, the controller 11 (the guidance image display program 17) allows the display section 13 to display a guidance image for the medium setting processing. In this regard, however, the content of description that will be made below using FIGS. 3 and 4 is just a specific example, and is not intend to narrow the scope of the disclosure of the invention.

Individual reference signs PA1, PA2, PA3, PB1, PB2, PB3, PC1, PC2, PC3, in FIG. 3 denote guidance images that may be displayed on the display section 13. A character string written in a rectangular box representing each of the guidance images indicates the content (the summary) of guidance provided by the each guidance image. For example, a first guidance image PA1 is an image for providing guidance to a user on an operation of “opening the front cover of the printer”, and provides guidance to the user using any appropriate illustration, any appropriate message (such as a message “open the front cover of this printer, please”) or any appropriate combination of an illustration and a message. In the present embodiment, a specific design of each of the guidance images does not matter particularly.

It is assumed that, in the example shown in FIG. 3, the guidance images PA1, PA2, and PA3 constitute an image group GA; the guidance images PB1, PB2, and PB3 constitute an image group GB, which is an image group subsequent to the image group GA; and the guidance images PC1, PC2, and PC3 constitute an image group GC, which is an image group subsequent to the image group GB. Further, in FIG. 3, individual rectangular boxes (corresponding to steps S100 to S180) each of which is enclosed by a dashed line indicate part of operations executed by a user, and individual rectangular boxes (corresponding to steps S200 to S250) each of which is enclosed by a full line indicate part of processes executed by the controller 11).

FIG. 4 very simply illustrates an example of the structure of the device 10 serving as the LFP from a lateral side. The device 10 includes a housing 20, and this housing 20 is supported by a leg portion 26. In a portion lower than the housing 20, a pair of roll holders (medium holding portion) 27 is fixed to the leg portion 26. The pair of roll holders 27 holds roll paper 30 from the left and right sides of the roll paper 30. The housing 20 includes a front cover 23, and this front cover 23 serves as a kind of lid. Further, in the inside of the housing 20, a transport roller (the transport portion) 21, a driven roller 22, a switch 24, a pair of medium holding plates 25, the sensors 16 (16a and 16b), and the like are disposed. The transport roller 21 is configured to be drivingly rotated by an unillustrated motor. The driven roller 22 is configured to pinch the printing medium between the transport roller 21 and the driven roller 22 itself. The switch 24 is configured to switch the position of the driven roller 22. The pair of medium holding plates 25 is configured to hold the printing medium from the left and right sides of the printing medium. Although omitted from illustration in FIG. 4, naturally, the controller 11 and other portions of the printing section 15 (i.e., the printing head, the carriage, the ink cartridges, and the like) are also disposed in the housing 20, and the operation panel (corresponding to the display section 13 and the input reception section 14) is disposed at an easily visible position on the front side of the housing 20.

When triggered by a predetermined input to the operation panel (corresponding to the display section 13 and the input reception section 14) by a user, the controller 11 allows the display section 13 to display the guidance image PA1, which is a first guidance image for the medium setting processing.

The user opens the front cover 23 (step S100). The user is able to easily understand that the front cover 23 is to be opened first, by viewing the guidance image PA1. In this regard, however, in the case where the user is a person skilled in the medium setting processing, the user is able to perform the following operations beginning with the opening of the front cover 23, without depending on the individual guidance images.

The guidance image PA2 is an image for providing guidance on an operation of “retracting the pair of medium holding plates”. Further, the guidance image PA3 is an image for providing guidance on an operation of “releasing the driven roller”. Through the executions of the above-described transition instructions onto the device 10, the user is able to allow the display of the guidance image on the display section 13 to transit from the guidance image PA1 to the guidance image PA2, and transit from the guidance image PA2 to the guidance image PA3. It depends on the intention of the user (the presence/absence of the transition instructions issued by the user) whether or not the transition from the guidance image PA1 to the guidance image PA2, and the transition from the guidance image PA2 to the guidance image PA3 actually occur.

Next, the user retracts the pair of medium holding plates 25 (step S110). As commonly known, the pair of medium holding plates 25 are located on the left and right sides of a printing medium to be transported by the transport roller 21, and the user is able to manually expand/narrow the distance between the holding plates 25, located on the left and right sides of the printing medium. The retraction of the medium holding plates 25 means an operation of expanding the distance between the holding plates 25, located on the left and right sides of the printing medium, in such a way that the holding plates 25 do not interfere with the printing medium.

Next, the user releases the driven roller 22 by operating the switch 24 (step S120). The switch 24 is capable of switching the position of the driven roller 22 between a pinching position and a releasing position. The pinching position is a position at which the driven roller 22 is located so close to the transport roller 21 that the driven roller 22 and the transport roller 21 are capable of pinching the printing medium therebetween, and the releasing position is a position at which the driven roller 22 is located so far from the transport roller 21 that the driven roller 22 and the transport roller 21 are incapable of pinching the printing medium therebetween. The release of the driven roller 22 means the movement of the driven roller 22 from the pinching position to the releasing position.

Here, a driven roller sensor 16a, which is a kind of the sensors 16, is a sensor for detecting whether the driven roller 22 has been moved to the releasing position, or not (or has been moved to the pinching position) in response to the operation of the switch 24. That is, the operation of “releasing the driven roller” corresponding to the guidance image PA3, which is the last guidance image of the image group GA, is one of the detection target operations SE. In response to the operation by the user in step S120, the driven roller sensor 16a detects that the driven roller 22 has been moved to the releasing position, and the relevant detection thereof is notified to the controller 11. Though this notification, the controller 11 recognizes the release of the driven roller 22 (step S200), and allows the display of the guidance image by the display section 13 to transit to the guidance image PB1, which is the first guidance image of the image group GB (step S210). In this case, if a guidance image having been displayed on the display section 13 until just before the relevant transition is not the guidance image PA3, but the guidance image PA1 or the guidance image PA2, the skip of one or more guidance images would have occurred in step S210.

The guidance image PB1 is an image for providing guidance on an operation of “attaching the roll paper”. Further, the guidance image PB2 is an image for providing guidance on an operation of “inserting the leading edge of the roll paper into the housing”. Further, the guidance image PB3 is an image for providing guidance on an operation of “pinching the roll paper with the rollers”. Naturally, through issuing the above-described transition instructions to the device 10, the user is able to allow the display of the guidance image on the display section 13 to transit from the guidance image PB1 to the guidance image PB2, and transit from the guidance image PB2 to the guidance image PB3.

Subsequently to step S120, the user attaches the roll paper 30 to the pair of roll holder 27 (step S130). Next, the user draws out the leading edge of the roll paper 30 having been attached to the pair of roll holder 27, and then, inserts the leading edge of the roll paper 30 into the housing 20 from the rear side of the housing 20 (see FIG. 4) (step S140). At this time, since the driven roller 22 is already released, the leading edge of the roll paper 30 easily passes though between the transport roller 21 and the driven roller 22, and then, proceeds inside the housing 20 toward the front side. Naturally, slit-shaped openings for allowing the roll paper 30 to pass through the housing 20 are secured in rear-side and front-side portions of the housing 20.

Here, a medium sensor 16b, which is a kind of the sensors 16, is located on the further front side than the rollers 21 and 22, and is a sensor capable of detecting that the leading edge of the printing medium has passed through. Accordingly, the operation of “inserting the leading edge of the roll paper into the housing” corresponding to the guidance image PB2 included in the image group GB is one of the detection target operations SE. In response to the operation by the user in step S140, the medium sensor 16b detects that the leading edge of the roll paper 30 has passed through, and the relevant detection thereof is notified to the controller 11. Through this notification, the controller 11 recognizes that the leading edge of the roll paper 30 has been inserted into the housing 20 (step S220). Here, any one of two kinds of specifications may be employed: one being a specification in which the controller 11 allows the display of the guidance image by the display section 13 to transit to the guidance image PB3 by being triggered by the insertion of the leading edge of the roll paper 30 into the housing 20 (step S230); the other one being a specification in which such a process in step S230 is not performed.

In this case, when the user has inserted the leading edge of the roll paper 30 into the housing 20 (step S140), there may occur a situation in which the leading edge of the roll paper 30 does not reach the position of the medium sensor 16b because of inadequate amount of the insertion. In such a case, the controller 11 is incapable of recognizing the insertion of the leading edge of the roll paper 30 into the housing 20. In order to avoid such an insufficient insertion of the roll paper 30, the device 10 may be configured to include a reporting section for giving a predetermined voice message when the leading edge of the printing medium has been detected by the medium sensor 16b. This configuration enables the user to remain to continue the insertion of the roll paper 30 until the receipt of the voice message, and enables the operation of “inserting the leading edge of the roll paler into the housing” to be properly executed.

Next, the user allows the driven roller 22 to return to the pinching position by operating the switch 24, and pinches the roll paper 30 with the rollers 21 and 22 (step S150). With this pinch of the roll paper 30 with the rollers 21 and 22, the position of the roll paper 30 is maintained even after the user has released his or her hold of the roll paper 30. As described above, the driven roller sensor 16a is capable of detecting that the driven roller 22 has been moved to the pinching position. Accordingly, the operation of “pinching the roll paper with the rollers” corresponding to the guidance image PB3, which is the last guidance image of the image group GB, is one of the detection target operations SE. In response to the operation by the user in step S150, the driven roller sensor 16a detects that the driven roller 22 has been moved to the pinching position, and the relevant detection thereof is notified to the controller 11. Through this notification, the controller 11 recognizes that the rollers 21 and 22 have pinched the roll paper 30 (step S240), and then, allows the display of the guidance image by the display section 13 to transit to the guidance image PC1, which is the first guidance image of the image group GC (step S250). In this case, if a guidance image having been displayed on the display section 13 until just before the relevant transition is not the guidance image PB3, but is the guidance image PB1 or the guidance image PB2, the skip of one or more guidance images would have occurred in step S250.

The guidance image PC1 is an image for providing guidance on an operation of “releasing the driven roller while holding the leading edge of the roll paper”. Further, the guidance image PC2 is an image for providing guidance on an operation of “drawing the leading edge of the roll paper up to a mark”. Further, the guidance image PC3 is an image for providing guidance on an operation of “pinching the roll paper with the rollers”. Naturally, through issuing the above-described transition instructions to the device 10, the user is able to allow the display of the guidance image on the display section 13 to transit from the guidance image PC1 to the guidance image PC2, and transit from the guidance image PC2 to the guidance image PC3.

The user executes the operations in steps S120 to S150 while being positioned mostly on the front side of the LFP (the device 10). For this reason, after the operation in step S150, the user moves to the front side of the LFP (the device 10), and then, releases the driven roller 22 by operating the switch 24 while holding the leading edge of the roll paper 30 (step S160). Next, the user draws out the leading edge of the roll paper 30 further until the leading edge thereof has reached the position of a predetermined mark (not illustrated) that is put on the front side of the housing 20 (in step S170). Further, in this state, the user allows the driven roller 22 to return to the pinching position by operating the switch 24, and then, pinches the roll paper 30 with the rollers 21 and 22 (in step S180). Although particularly not shown in FIG. 3, the release of the driven roller 22 (the movement of the driven roller 22 to the releasing position) in step S160 and the pinch of the roll paper 30 (the movement of the driven roller 22 to the pinching position) in step S180 are the targets of detections by the driven roller sensor 16a, and thus, the controller 11 is capable of allowing the display of the guidance image to transit by being triggered by such detections by the driven roller sensor 16a.

After having allowed the display section 13 to display the guidance image PC3, the controller 11 is capable of allowing other guidance images for the medium setting processing to be further displayed. The other guidance images for the medium setting processing are various kinds of guidance screens for providing guidance via the operation panel on operations, such as an operation of moving the pair of medium holding plates 25 to the position at which the roll paper 30 is held from the left and right sides by the medium holding plates 25, an operation of closing the front cover 23, and an operation of inputting, through the operation panel, various kinds of information in relation to the attached roll paper 30 (i.e., information relating to a kind of medium, the remaining amount of the roll paper, which of the outer winding surface and the inner winding surface the printed surface of the roll paper is, and the like).

As described above, according to the present embodiment, when a transition instruction for instructing a transition of the display of the guidance image has been received from a user, the device 10 is capable of allowing the display of the guidance image by the display section 13 to transit on a guidance-image by guidance-image basis. On the other hand, when a predetermined operation has been detected by one of the sensors 16, the controller 10 is capable of allowing the display of the guidance image by the display section 13 to transit in such a way as to skip one or more guidance images. Thus, a user who is not skilled in the settings of the device 10 is able to execute the settings with certainty by confirming the guidance images while allowing the guidance images to transit on a guidance-image by guidance-image basis manually (in a way using the transition instructions). On the other hand, a user who is skilled in the settings of the device 10 is able to, without viewing the guidance images and issuing the transition instructions, successively execute the operations while allowing the display of the guidance image to transit automatically.

For example, the user who is skilled in the settings of the device 10 is able to, in a status in which the first guidance image P1 is displayed on the display section 13, sequentially execute the operation 1, the operation 2, operation 3, (see FIG. 2) without particularly viewing the guidance images. During these operations, even though the user does not enter the transition instructions for allowing the display of the guidance image to proceed from the guidance image P1 to the following guidance images P2, P3, . . . , when having been triggered by the detection of the operation 3, which is one of the detection target operations SE, the device 10 allows the display of the guidance image by the display section 13 to transit to the guidance image P4 corresponding to the operation 4 subsequent to the operation 3. That is, since some guidance images (the guidance images P2 and P3 in this case) are automatically skipped, the user is released from the burden of switching the guidance images one by one manually (in a way using the transition instructions). Particularly, in the case where the device 10 is the LFP, such as described above, when performing the medium setting processing, the user performs the individual operations while moving to the rear side and the front side of the device 10. Thus, it may be troublesome for the user to view the display section 13 of the device 10 one by one while performing the various operations. In view of such a situation, it can be said that the configuration according to the present embodiment of the invention reduces the burden on the user to a great degree because, in the present embodiment of the invention, even though a user does not perform inputting for allowing the display of the guidance image to transit one by one, the display of the guidance image transits along with the skip in such a way as to be in conjunction with the progress of the operations by the user.

The invention is not limited to the embodiment having been described so far, but can include various embodiments.

As one of modification examples, the controller 11 (the guidance image display program 17) may be configured to, when an execution of an operation corresponding to the last guidance image of an image group has been detected by one of the sensors 16, allow the display of the guidance image by the display section 13 to transit to the initial guidance image of an image group subsequent to the relevant image group under a condition that, among operations corresponding to guidance images constituting the relevant image group, all of one or more operations detectable by one or more corresponding ones of the sensors 16 (i.e., all of one or more detection target operations SE) have already been executed.

Such a modification example will be described using the displays of the image groups GB and GC (see FIG. 3).

It is assumed that, through the detection by the driven roller sensor 16a, the controller 11 has recognized the operation of “pinching the roll paper with the rollers” corresponding to the guidance image PB3, which is the last guidance image of the image group GB (step S240). In this case, the controller 11 determines whether or not all of detection target operations SE among operations corresponding to the guidance images PB1, PB2, and PB3 constituting the image group GB have already been executed. The detection target operations SE among the operations corresponding to the guidance images PB1, PB2, and PB3 constituting the image group GB are an operation corresponding to the guidance image PB2 and an operation corresponding to the guidance image PB3. The controller 11 has already recognized that the operation of “pinching the roll paper with the rollers” corresponding to the guidance image PB3 is already executed. Thus, the controller 11 determines whether or not it is already detected by the medium sensor 16b that the leading edge of the roll paper 30 has passed through. Further, in the case where it is already detected that the relevant leading edge has passed through, it can be said that the operation of “inserting the leading edge of the roll paper into the housing” corresponding to the guidance image PB2 has been also executed, and thus, the controller 11 allows the process flow to proceed from step S240 to step S250 (allows the display of the guidance image by the display section 13 to transit to the guidance image PC1, which is the first guidance image of the image group GC). According to this configuration, when the content of a guidance image displayed on the display section 13 has been allowed to automatically transit, a user is able to recognize that one or more operations to be performed before the relevant transition (one or more detection target operations SE at minimum) have been properly executed.

Further, the controller 11 may be configured to, when an operation corresponding to the last guidance image of an image group has been detected by one of the sensors 16, unless the condition that, among operations corresponding to guidance images constituting the relevant image group, all of one or more detection target operations SE have already been executed is satisfied, maintain the display of the guidance image by the display section 13. For example, when the leading edge of the roll paper 30 has not yet been detected by the medium sensor 16b in the stage of step S240 described above, since the operation corresponding to the guidance image PB2 is not yet executed, the controller 11 does not allow the process flow to proceed to step S250 (does not execute the transition to the guidance image PC1). In this case, the controller 11 maintains a guidance image that has been displayed by the display section 13 until then. If the guidance image PB2 of the image group GB has been displayed on the display section 13 until then, the controller 11 maintains the display of the guidance image PB2. According to this configuration, in the case where, while a user proceeds with the operations, the content of the display of the guidance image on the display section 13 is not changed, the user is able to find out that operations that should have been executed until then are incomplete. Thereafter, when the above condition is satisfied, the controller 11 can allow the process flow to proceed to step S250.

As another modification example, the device 10 may be configured to further include a reporting section 18 (see FIG. 1). This reporting section 18 performs reporting for prompting a user to execute an operation. The reporting section 18 performs reporting in conjunction with the guidance image displayed by the display section 13. The reporting section 18 is, for example, a voice circuit configured to output voice messages, or a light emitting unit using an LED or the like and configured to perform light emitting or light flickering. Every time the controller 11 allows the display of the guidance image by the display section 13 to transit, in order to prompt a user to execute an operation on which guidance is provided by a guidance image after the transition, the controller 11 allows the reporting section 18 to output a predetermined voice message or allows the reporting section 18 to perform predetermined light emitting or light flickering. According to this configuration, errors made by a user on the operations are reduced.

A plurality of the reporting sections 18 may exist in the device 10. Further, each of the reporting sections 18 may be disposed at a position in the vicinity of a portion that is the target of a corresponding one of operations in the device 10. For example, the reporting sections 18 are disposed at positions in the vicinity of all of or part of portions that are the targets of the operations having been described using FIGS. 3 and 4, that is, a position in the vicinity of the front cover 23, a position in the vicinity of the medium holding plates 25, a position in the vicinity of the switch 24, a position in the vicinity of the pair of roll holder 27, and the like. Further, the controller 11 allows each of the reporting sections 18 to perform reporting in conjunction with a corresponding guidance image displayed by the display section 13. For example, when allowing the display section 13 to display the guidance image PA1, the controller 11 allows one of the reporting sections 18 that is disposed in the vicinity of the front cover 23 to perform light emitting or light flickering, or output a voice message. Further, when allowing the display section 13 to display the guidance image PA2, the controller 11 allows one of the reporting sections 18 that is disposed in the vicinity of the medium holding plates 25 to perform light emitting or light flickering, or output a voice message. According to this configuration, a user is able to, without failing to recognize portions that are the targets of operations in relation to the device 10, efficiently execute the necessary operations.

What is claimed is:

1. An electronic device comprising:
a display;
a processor configured to allow the display to display guidance images for providing guidance on operations of the electronic device; and
at least one sensor configured to detect a user's execution of at least one operation among the operations,
wherein, when receiving a transition instruction for instructing a transition of the guidance image, the processor allows the display of the guidance image to transit on a guidance-image by guidance-image basis, and when an execution of a predetermined operation is detected by the at least one sensor, the processor allows the display of the guidance image to transit in such a way as to skip a plurality of guidance images among the guidance images.

2. The electronic device according to claim 1,
wherein the processor is configured to enable the display to sequentially display each of a plurality of guidance image sets, each of the guidance image sets including a plurality of guidance images each of which is associated with a corresponding one of a plurality of successive operations, and
wherein, when an execution of one of the operations that corresponds to a last guidance image of a first guidance image set among the guidance image sets is detected by the at least one sensor, the processor allows the display of the guidance image by the display to transit to an initial guidance image of a second guidance image set subsequent to the first guidance image set among the guidance image sets.

3. The electronic device according to claim 2, wherein the successive operations associated with the respective guidance images constituting each of the guidance image sets include one or more operations undetectable by the at least one sensor.

4. The electronic device according to claim 2, wherein, when the execution of one of the operations that corresponds to the last guidance image of the first guidance image set among the guidance image sets is detected by the at least one sensor, under a condition that all of operations each associated with a corresponding one of guidance images constituting the first guidance image set and each of which is detectable by at least one sensor have already been executed, the processor allows the display of the guidance image by the display to transit to the initial guidance image of the second guidance image set subsequent to the first guidance image set among the guidance image sets.

5. The electronic device according to claim 4, wherein, when the execution of the one of the operations that corresponds to the last guidance image of the first guidance image set is detected by the at least one sensor, unless the condition is satisfied, the processor maintains the display of the guidance image by the display.

6. The electronic device according to claim 2, wherein, when an execution of one of the operations that corresponds to, among guidance images constituting the first guidance image set, a guidance image not corresponding to the last guidance image is detected by the at least one sensor, the processor allows the display of the guidance image by the display to transit to, among the guidance images constituting the first guidance image set, a guidance image subsequent to the guidance image corresponding to the detected one of the operations.

7. The electronic device according to claim 2, wherein, when receiving the transition instruction in a status in which, among guidance images constituting the first guidance image set, a guidance image not corresponding to the last guidance image is being displayed by the display, the processor allows the display of the guidance image to transit by one guidance image regardless of whether or not one of the operations that corresponds to the guidance image being displayed by the display is detected by the at least one sensor.

8. The electronic device according to claim 2, wherein, among guidance images constituting each of the guidance image sets, each of guidance images not corresponding to the last guidance image includes a reception portion for receiving the transition instruction.

9. The electronic device according to claim 1, further comprising a reporting section configured to perform reporting for prompting a user to execute the operation,
wherein the reporting section performs the reporting in conjunction with the guidance image displayed by the display.

10. The electronic device according to claim 9, the reporting section is disposed in a vicinity of a portion that is a target of the operation in the electronic device.
